(19) United States
(12) Patent Application Publication
(10) Pub. No.: US 2022/0040907 A1
(43) Pub. Date: Feb. 10, 2022

(54) METHOD AND DEVICE FOR EMBOSSING LICENSE PLATES, IN PARTICULAR VEHICLE LICENSE PLATES

(71) Applicant: Tönnjes ISI Patent Holding GmbH, Delmenhorst (DE)

(72) Inventor: Björn Beenken, Ganderkesee (DE)

(73) Assignee: Tönnjes ISI Patent Holding GmbH, Delmenhorst (DE)

(21) Appl. No.: 17/414,409

(22) PCT Filed: Dec. 18, 2019
(86) PCT No.: PCT/EP2019/086024

§ 371 Date: Jun. 16, 2021

(30) Foreign Application Priority Data
Dec. 21, 2018 (DE) 10 2018 009 979.3
Jan. 18, 2019 (DE) 10 2019 000 320.9

(51) Int. Cl. B29C 59/02; B44B 5/00

(52) U.S. Cl. CPC B29C 59/02; B60R 13/10; B44B 5/0076

(57) ABSTRACT

The sequence of characters provided for an individual license plate is embossed in a license plate blank. The known methods are very time-intensive and inflexible. The invention achieves a method and a device for embossing license plates, in particular motor vehicle license plates, said method and said device being easy to handle and flexible to use. This is achieved in that a handling installation retrieves the embossing die parts required for the respective license plate to be embossed from a magazine and successively places said embossing die parts onto two die holding frames.

### CROSS REFERENCE TO RELATED APPLICATIONS

This application is the US National Phase of and claims the benefit of and priority on International Application No. PCT/EP2019/086024 having an international filing date of 18 Dec. 2019, which claims priority on and the benefit of German Patent Application No. 10 2018 009 979.3 having a filing date of 21 Dec. 2018 and German Patent Application No. 10 2019 000 320.9 having a filing date of 18 Jan. 2019.

### BACKGROUND OF THE INVENTION

### Technical Field

The invention relates to a method for embossing license plates, in particular motor vehicle license plates, wherein embossing dies having characters corresponding to the license plate to be embossed are individually assembled, in that the embossing dies required for the respective license plate to be embossed are retrieved from a magazine by a handing installation, a license plate blank is fed to the embossing dies, and the characters in an embossing installation are embossed in the license plate blank by the embossing dies. The invention furthermore relates to a device for embossing license plates, in particular motor vehicle license plates, having at least one magazine for a supply of embossing dies, at least one store for license plate blanks, at least one embossing installation, and at least one handling installation for handling the embossing dies.

### Prior Art

License plates, in particular motor vehicle license plates, possess an individual sequence of characters or numerals, respectively. These characters can be letters and/or numbers or other punctuation marks or symbols. The number of characters and the sequence and the arrangement of the latter on the license plates are established so as to be specific to countries and are thus different. The motor vehicle license plates are typically composed of letters as well as of numerals in a specific sequence. There are also states in which the motor vehicle license plates have only letters or only numerals. Other states permit only specific letters or characters or symbols for motor vehicle license plates. The same may also apply to numerals. There are moreover points of differentiation in terms of the shape of the license plates and the associated arrangement of the characters on the license plate.

The sequence of the letters and/or numerals provided for the individual license plate in license plates of the type discussed here is embossed in a license plate blank. This blank is typically a flat blank cut from thin sheet metal, for example aluminum, a thin plastic board, or similar. The blank can optionally also already be provided with recurring embossings such as, for example, an encircling peripheral embossing or else specific combinations of characters which may always be identical in the case of a comparatively large number of license plates. The individual set of characters is embossed in the as yet non-embossed or pre-embossed blanks by embossing dies. Each embossing die is composed of an upper part into which a negative of the character is incorporated, and a lower part on which a positive matching the negative of the character is configured. The positive and the negative of the embossing die as separate die parts are at all times combined so as to form a unit and are always moved or placed in combination, or stored in a magazine, respectively. For pressing the license plate, the blank is placed between the positive and the negative. One embossing die, or one positive and one negative, respectively, is correspondingly aligned for each character to be embossed in the blank, such that a plurality of embossing dies lying next to one another are assigned to the blank when embossing.

A corresponding supply of the required embossing dies, or of the negatives and positives, respectively, is stored in a magazine. The embossing die parts, or the characters, respectively, required for individually embossing the respective license plate are retrieved from the magazine and arranged in a die receptacle, or a frame, respectively, so as to form the desired set of characters. This arrangement is very time-intensive and prone to errors.

### BRIEF SUMMARY OF THE INVENTION

The invention is based on the object of achieving a method and a device for embossing license plates, in particular motor vehicle license plates, said method and said device being constructed in a simple manner and able to be flexibly used.

A method for achieving this object is a method for embossing license plates, in particular motor vehicle license plates, wherein embossing dies having characters corresponding to the license plate to be embossed are individually assembled, in that the embossing dies required for the respective license plate to be embossed are retrieved from a magazine by a handing installation, a license plate blank is fed to the embossing dies, and the characters in an embossing installation are embossed in the license plate blank by the embossing dies, characterized in that two die holding frames, specifically a lower die holding frame and an upper die holding frame, which are movable relative to one another are successively populated by the handling installation with at least one positive of an embossing die and with at least one negative of an embossing die.

Accordingly, it is provided that the embossing dies, in particular at least one negative and at least one positive, required for the respective license plate to be embossed are retrieved from a magazine by a handing installation, and a license plate blank is fed to the embossing dies. The embossing dies including the license plate blank are thereafter transported to an embossing installation for embossing the blank so as to form the license plate. In order for the die holding frames to be populated with at least one negative and at least one positive of the embossing die, two die holding frames which are movable relative to one another are successively approached by the handling installation. The handling installation herein successively places in an automated manner one negative and one positive of the same embossing die into the two frames. It can moreover be provided that first a plurality of negatives of different embossing dies, and thereafter a plurality of positives of the corresponding embossing dies, are positioned in the frames. The frames are a lower die holding frame and an upper die holding frame which is disposed above the lower die holding frame. As a result of the two frames being populated in steps with in each case one part of an embossing die by the handling installation, the license plate can be embossed, or prepared for embossing, respectively, in a rapid and reliable and flexible manner.

The invention can in particular provide that, for placing the at least one positive and the at least one negative of the same character onto the die holding frame, and for later lifting the at least one positive and the at least one negative from the frame, the lower die holding frame is displaced horizontally and parallel to the upper die holding frame. Alternatively, it can likewise also be provided that the upper die holding frame is displaced horizontally and parallel to the lower die holding frame. The relative relocation of the two holding frames is performed precisely to the extent that the embossing die parts, or the negatives and the positives, respectively, are able to be placed into the holding frame. The negatives and positives, which here are configured in the manner of plates, are placed onto an upper side of the holding frames. The frames here are configured in such a manner that said frames receive the negatives and positives on the peripheries thereof without said negatives and positives dropping through the frame.

It is furthermore preferably provided that first at least one negative of an embossing die, preferably a plurality of negatives of a plurality of embossing dies, are placed onto the upper die holding frame, and thereafter the corresponding positive of the embossing die, preferably the corresponding positives of the embossing dies, are placed onto the lower die holding frame. This placing sequence has the advantage that the embossing die parts, or the negatives and positives, respectively, of a character can be retrieved directly from a magazine in which the dies are stored. The negatives and positives of an embossing die are stacked on top of one another in such a manner in the magazine that the upper embossing die part, or the negative, respectively, is stored on the lower embossing die part, or the positive, respectively. When the embossing die parts upon pressing are later lifted, the positive is first placed back at the corresponding position in the magazine, and the corresponding negative is thereafter placed back on the corresponding positive in the magazine.

It can moreover be furthermore provided that upon populating, or placing the at least one negative and the at least one positive onto the die holding frames, respectively, the license plate blank is placed by the handling installation onto the lower die holding frame, preferably onto the positives of the embossing dies. The license plate blank here is retrieved from a store for the blanks by the handling installation. It can be provided that the license plate blank already has an embossed border by way of which said license plate blank is placed onto a corresponding receptacle, in particular a corresponding peripheral structure, on the lower die holding frame. As a result, the license plate blank can no longer slide out of place during the further movement of the lower die holding frame. Alternatively, in particular when the license plate does not have any pre-embossing, it can be provided that protrusions which at least temporarily fix the blank in the position thereof above the positives are disposed in the lower die holding frames.

A further advantageous exemplary embodiment of the invention can provide that the upper and the lower die holding frame are aligned on top of one another by a horizontal and parallel relative movement, the lower die holding frame being in particular displaced below the upper die holding frame such that the corresponding positives and negatives of the embossing dies are aligned on top of one another, wherein the license plate blank is positioned between the positives and the negatives. This method is performed by means of a linear drive which is activated after the blank has been placed onto the lower die holding frame. The lower die holding frame here, from a movement which is initially not guided, is fed to one, or at least two rail(s), respectively. The lower die holding frame is guided accurately by these rails to the position which is disposed exactly and reproducible below the upper die holding frame. The lower die holding frame here is guided by the rails and fixed in terms of its position.

Moreover, it is preferably provided that the two die holding frames which are aligned on top of one another are relocated vertically relative to one another, wherein the lower frame is preferably moved toward the upper frame and thereafter both die holding frames are conjointly relocated into the embossing installation in which the die holding frames are mutually compressed. Here, the lower die holding frame is in particular relocated at a height level, or in a plane, respectively, which is identical to a height level, or a plane, respectively, of press ram of the embossing installation. As soon as the two die holding frames are correspondingly mutually positioned, both are conjointly moved onto the pressing table. In order for the two die holding frames to be mutually oriented in a defined manner, the lower holding frame can have at least one pin, preferably two or three pins, which when approaching the upper die holding frame are guided into corresponding openings. The pins and the corresponding openings here are dimensioned in such a manner that a fixed or reproducible, respectively, arrangement of the two frames relative to one another takes place. It can likewise be provided that the two frames have other means for relative alignment.

It can in particular be provided that, prior to converging the two die holding frames, the negatives and positives lying next to one another on the upper die holding frame and the lower die holding frame are in each case pushed together by one sliding means so as to avoid potential, undesirable intermediate spaces between the individual embossing die parts, or between the individual negatives and between the individual positives, respectively.

The invention can furthermore provide that the two frames upon pressing are conjointly relocated from the press, or pushed off the pressing table, respectively, and, upon vertically lowering the lower die holding frame relative to the upper die holding frame, the lower die holding frame is relocated horizontally below the upper die holding frame. As soon as the two die holding frames have been relocated horizontally from one another, at least one positive and thereafter one negative are retrieved from the frames by the handling installation and returned to the magazine. In so far as a license plate which differs from the preceding license plate in terms of more than one character is to be embossed in a further step, a corresponding plurality of negatives or positives have to be replaced. In so far as a front motor vehicle license plate has to be embossed first, and a rear motor vehicle license plate has to be embossed thereafter, only the embossed license plate is replaced by a license plate blank without the embossing dies being replaced here. The embossing procedure is then repeated for the second license plate of the pair of license plates.

Thereafter, the required embossing dies, in particular the required negatives and positives, are preferably picked and retrieved from a magazine and placed in the correct sequence onto at least one upper and at least one lower die holding frame by the handling installation having at least one acquisition means that is movable in the three-dimensional space. Likewise, a license plate blank is retrieved from at least one store and placed onto the lower die holding frame, or onto the positives, respectively, by the handling installation. It is furthermore conceivable that subsequently a further lower die holding frame is populated with a further license plates blank by the handling installation. After completion of the embossing procedure of the license plate blank so as to form the license plate, the license plate is then lifted again from the lower die holding frame, or from the positives of the embossing dies, respectively, and fed to an outfeed conveyor by the handling installation. The acquisition means, configured in the manner of a robot, at a front end has a receiving means. This means can be, for example, a gripper, a magnet, in particular a solenoid, or a suction cup. The embossing die parts as well as the license plate blank, or the license plate, respectively, can be easily and reliably acquired and sat down again by this receiving means.

Moreover, it can be furthermore provided according to the invention that lower and upper die holding frames of a plurality of, preferably two, embossing installations are alternatingly or successively populated with negatives, positives and license plate blanks by the handling installation. For example, it can be provided that two embossing installations are disposed opposite one another and are populated with the embossing dies in an alternating manner or in parallel, respectively, by the handling installation. The magazine for the embossing dies, in particular the negatives or positives, as well as the store for the blanks can be disposed so as to be centric between the embossing installations. As a result of this combination of two embossing installations, the handling installation can be utilized in a particularly efficient manner. In particular, while one embossing installation embosses a blank so as to form a license plate, the further embossing installation can in particular be populated with the negatives and positives.

Moreover, it can furthermore be provided that for embossing license plate blanks of different types, in particular of different dimensions, the die holding frames of the at least one embossing installation are replaced so as to correspond to the shape of the license plate blank. For example, only the die holding frames have to be changed when a changeover is to be made from a rather elongate license plate blank to a rather square license plate blank. The receptacles in the die holding frames for the embossing installations, in particular for the negatives and positives, can be of identical configuration. The die holding frames and the blanks, and potentially also at least some embossing dies, in particular at least some negatives and positives, thus have to be adapted or replaced, respectively, for embossing different shapes of license plates. It may readily be the case that different type fonts and thus different sets of embossing dies have to be used for different formats of license plates. Alternatively, it is moreover conceivable for a magazine for the embossing dies to be equipped with all type fonts from the outset.

A further exemplary embodiment of the invention can provide that the embossing dies, in particular the positives of the negatives, as well as embossing inserts, prior to the die holding frames being converged, are pushed together, centered and/or imparted in the die holding frames, specifically by being impinged by a lateral or vertical force, respectively, which is imparted by an actuator, in particular a centering cylinder. This impingement by a force or a brief impulse takes place in a pulsed manner, both for the embossing dies or embossing inserts, respectively, of the lower die holding frame as well as of the upper die holding frame. It is ensured by this impingement by a force that the characters are always embossed in the blanks at the envisaged position.

A further exemplary embodiment moreover illustrates that prior to populating the die holding frames with the embossing dies, in particular the negatives and positives, the latter are identified by the handling installation, wherein the handling installation has a sensor means by way of which corresponding identifying features of the negatives and positives are detected. As a result, it can be avoided that embossing dies which have been wrongly inserted into the magazine are acquired and placed onto the holding frames. By identifying individual embossing dies it can be guaranteed that the correct characters are always embossed, on the one hand, and it can be verified, for example, how often specific embossing dies have already been used, on the other hand. The servicing, or the replacement of specific embossing dies by new embossing dies, respectively, can thus, in particular, be managed in a reproducible and reliable manner.

A device for achieving the object mentioned at the outset is a device for embossing license plates, in particular motor vehicle license plates, having at least one magazine for a supply of embossing dies, at least one store for license plate blanks, at least one embossing installation, and at least one handling installation for handling the embossing dies, characterized by two die holding frames, specifically a lower die holding frame and an upper die holding frame, which are movable relative to one another for receiving at least one positive of the embossing die and at least one negative of the embossing die.

Accordingly, it is provided that the device has at least one magazine for a supply of embossing dies, at least one store for license plate blanks, at least one embossing press, and at least one handling installation for handling the embossing dies. The device moreover has two die holding frames, specifically a lower die holding frame and an upper die holding frame, which are movable relative to one another and which serve for receiving at least one positive of the embossing die and at least one negative of the embossing die. As a result of the relative maneuverability of the die holding frames, the latter can be successively populated with the embossing die parts, or the corresponding negatives and positives, respectively, by the handling installation. As a result of the frames being populated with the embossing die parts in this stepped manner, the license plates can be embossed in a rapid, simple as well as reliable and flexible manner.

The invention can moreover provide that the lower die holding frame is able to be guided in at least one, preferably in two, rail(s), wherein the at least one rail aligns the lower die holding frame below the upper die holding frame. The rail can engage in corresponding clearances of the lower die holding frame. It can be provided here that the rails are only temporarily brought together with the lower die holding frame. A movement of the lower die holding frame transversely to the horizontal relative movement in relation to the upper die holding frame is suppressed by the rails. The lower die holding frame can thus be relocated relative to the upper die holding frame in a reproducible manner.

Moreover, a further particularly advantageous exemplary embodiment of the present invention can provide that the lower and/or the upper die holding frame for converging the die holding frames is/are assigned to a lifting means, and/or that the lower and/or the upper die holding frame for conjoint or separate horizontal relocation is/are assigned to at least one translational motion means. Here, linear drives can be assigned to the lifting means and/or the translational motion means. It is moreover conceivable for the lifting means in particular to be pneumatically operatable.

It can preferably be provided according to the invention that the lower die holding frame has at least one first means for alignment, and the upper die holding frame has at least one second means for alignment, wherein the first and the second means are brought together and the die holding frames are mutually aligned when vertically converging the die holding frames. As a result of these means, which may be configured as a pin and a corresponding opening, for example, the two frames are mutually aligned in a reproducible manner. The frames thus aligned are then guided into the embossing installation in which said frames are able to be impinged from above and/or from below at a defined pressure.

A further advantageous feature of the invention can be seen in that the handling installation is configured in the manner of a robot and serves for placing embossing dies, in particular a positive and a negative, required for embossing the license plate onto the die holding frames, whereby the handling installation has at least one acquisition means which is movable in a plurality of axes in the three-dimensional space, wherein the acquisition means is movable in the three-dimensional space by movable arms of the handling installation. The handling installation automatically and gradually picks the required embossing dies, or the negatives and positives, respectively, from the magazine and transfers said embossing dies, or negatives and positives, respectively, in the correct sequence to the holding frames where the handling installation simultaneously sets down the die parts at the envisaged position. The embossing dies are automatically retrieved from the magazine in the sequence of the characters on the license plate to be produced and positioned at the correct location on or in the holding frame. To this end, the handling installation is configured as a robot which in particular also serves as a centering unit. The handling installation has an acquisition means which is movable in multiple axes. The acquisition means can be gripper, a vacuum, or else magnets which are suitable for gripping and firmly holding in each case at least one selected embossing die and/or else a blank for producing the license plate, so as to transport the embossing die, or the license plate blank, respectively, to the desired location and there set down said embossing die or license plate blank. As a result of the acquisition means being movable in multiple axes, said detection means can spatially reorientate the respective embossing die, or the blank, respectively, as a result of which the magazine for the embossing die parts, the store for the license plate blanks, and the die holding frames may not only be situated at different positions of the device but also at different height levels which may optionally be variable, as is the case with blanks which are stacked on top of one another in the store, for example.

According to a further advantageous design embodiment of the invention, the handling installation is provided with a plurality of, preferably three, movable arms which represent the centering unit and are in each case movable by way of one rotation axis. The arms form preferred parallelograms. The handling installation thus configured, which is also referred to as a delta robot, holds the acquisition means at all times in the same alignment in all conceivable positions within a spatial, three-dimensional region. As a result thereof, the acquisition means can approach so as to grip an embossing die or a blank in the same direction, and set down the embossing die or the blank, respectively, at another location without tilting or pivoting. It is however also conceivable for the acquisition means to be disposed on the handling installation such that said acquisition means, while maintaining the direction, can perform other movements, in particular rotating movements, in a targeted manner, for example so as to rotate the license plate blank and/or an embossing die part from the position in the store, or in the magazine, respectively, to another position which the embossing die part, or the license plate blank, respectively, is to assume in the holding frame or beside the latter, respectively.

The invention can moreover provide that the lower die holding frame is assigned at least one detent which serves for positioning and/order aligning the respective license plate blank. As result thereof, the license plate blank is in particular placed onto or into the frame in a defined relative position in relation to the die parts. As a result thereof, the blank, when being placed onto the holding frame, is simultaneously aligned at the desired or required relative position to the positives. Alternatively or additionally, it is also conceivable for at least one detent to be assigned to the embossing die parts.

The invention can moreover provide that the device is assigned at least two embossing installations having in each case one lower die holding frame and one upper die holding frame, wherein both embossing installations are able to be operated by the same handling installation. The two embossing installations here can be mutually positioned in such a manner that the magazine for the embossing installations and/or the store for the blanks are/is positioned between the two embossing installations. As a result of this positioning, both embossing installations can be populated or served, respectively, by the handling installation in a particularly time-efficient manner. For example, while a blank is embossing in an embossing installation, the handling installation can meanwhile populate the die holding frames of the other embossing installation, and vice versa. In this way, the handling installation is utilized to a maximum degree.

It is furthermore conceivable that the embossing dies, in particular the negatives and positives, have identifying features, and that the handling installation has a sensor means, wherein the identifying features are able to be read by the sensor means of the handling installation. The identifying means can be an engraving which can be visually detected by the corresponding sensor means, an electronic identifying feature such as, for example, a data memory, a wireless chip or a RFID, which is likewise to be read by a corresponding means, or a comparable means for identification. The character of the corresponding die or any other symbol can be stored as an identification. The handling installation, or the sensor means of the handling installation, respectively, can be connected to a control installation which compares the scanned identifications with predefined identifications, or nominal identifications, respectively, and in the event of any discrepancy generates a corresponding signal or a corresponding countermeasure. Information pertaining to how often each die has been used in which period of time is likewise stored by the control unit. As a result, an operator can establish which dies have to be replaced due to wear. The degree of wear can be measured based on how often a die has been used for a specific blank material within a specific temporal interval, for example.

### BRIEF DESCRIPTION OF THE DRAWINGS

A preferred exemplary embodiment of the invention will be explained in more detail hereunder by means of the drawings in which:

FIG. 1 shows a view of two die holding frames;

FIG. 2 shows a schematic illustration of a device during a method step;

FIG. 3 shows a schematic illustration of the device during a further method step;

FIG. 4 shows a schematic illustration of the device during a further method step;

FIG. 5 shows a schematic illustration of the device during a further method step;

FIG. 6 shows a schematic illustration of the device during a further method step;

FIG. 7 shows a schematic illustration of the device during a further method step;

FIG. 8 shows a schematic illustration of the device during a further method step; and

FIG. 9 shows a schematic illustration of the device during a further method step.

### DETAILED DESCRIPTION OF PREFERRED EMBODIMENTS

The device 10 shown serves for producing license plate, in particular motor vehicle license plates 11, specifically for embossing an individual sequence of characters in a license plate blank 12 for the motor vehicle license plate 11. In the device 10 shown here, only the individual sequences of characters and optionally symbols are embossed in the license plate blank 12. However, the blank 12 may also be already pre-embossed, for example with an encircling peripheral embossing 13 and/or recurring letters, characters, numerals or symbols. The license plate blank 12 is composed of steel or aluminum sheet or else optionally a plastic board or film. While the license plate blank 12 of steel or aluminum is cold-embossed, the embossing of a blank 12 of plastics material can take place in a warm or heated state. It is likewise also conceivable for the blank 12 not to be heated.

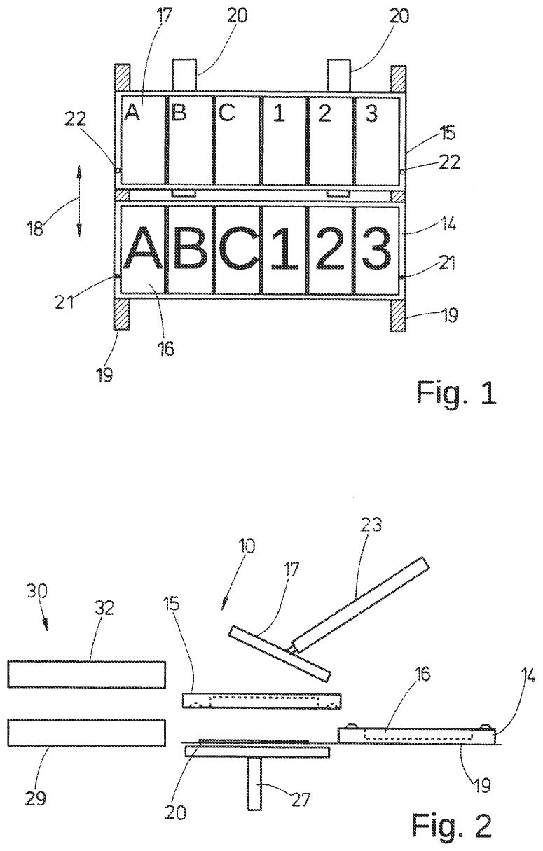

The device 10 shown here has two die holding frames, specifically a lower die holding frame 14 and an upper die holding frame 15 (FIG. 1). The two die holding frames 14, 15 are displaced in a mutually parallel manner and arranged on top of one another. In the exemplary embodiment illustrated here, six embossing dies, or six positives 16 of six embossing dies, respectively, are positioned in the lower die holding frame 14. Corresponding to the position of the positives 16, negatives 17 of the embossing dies are placed on the upper die holding frame 15. Each pair of one positive 16 and one negative 17 forms one embossing die. One character can be embossed by each individual embossing die, or pair consisting of one negative 17 and one positive 16, respectively. The two embossing die parts here are movable in a mutually independent manner. The die holding frames 14, 15 are configured in such a manner that the individual positives 16 or negatives 17, respectively, can be placed onto the holding frame 14, 15 without the positive 16 or negatives 17, respectively, dropping through the holding frames 14, 15. To this end, the positives 16 and the negatives 17 have corresponding protrusions which are congruent with the frames 14, 15.

The lower die holding frame 14 as well as the upper die holding frame 15 are mounted so as to be movable along the direction of the arrow 18, or can be moved in a reciprocating manner by drives not illustrated, respectively. The lower die holding frame 14 is relocated along the linear drives 19 below the upper die holding frame 15. The lower die holding frame 14 here slides on rails 20. These rails 20 engage in a receptacle, not illustrated, on a lower side of the lower die holding frame 14 and have the effect that the lower die holding frame 14 is fixed transversely to the direction of the arrow 18. As soon as the lower die holding frame 14 is placed below the upper die holding frame 15, the lower die holding frame 14 is lifted, specifically toward the die holding frame 15. The lower die holding frame 14 has two pins 21 for mutually aligning or fixing the frames 14, 15, or the negatives 17 and the positives 16, respectively. These pins 21, when lifting the lower die holding frame 14, are moved in openings 22 in the upper die holding frame 15, as a result of which the two frames 14, 15 are fixed relative to one another.

However, before the lower die holding frame 14 is relocated below the upper die holding frame 15, the positives 16 and the negatives 17 are first automatically placed into the frame 14, 15 by a handling installation, or an acquisition means 23, respectively, so as to correspond to the motor vehicle license plate 11 to be produced. Here, the negative 17 is first retrieved from a magazine, not illustrated, for the embossing dies and set down at a corresponding location on the upper tool holding frame 15. Thereafter, the corresponding positive 16 of the embossing die is retrieved from the magazine by the acquisition means 23 and placed onto the corresponding location on the lower die holding frame 14. This is repeated until the correct characters for the license plate to be embossed are implemented on the frames 14, 15.

In a further step, the license plate blank 12 is retrieved from a supply for license plate blanks 12 by the acquisition means 23, and placed onto the lower die holding frame 14, or on the positives 16, respectively. In the exemplary embodiment illustrated here, the license plate blank 12 already has a peripheral embossing 13. This peripheral embossing 13 communicates with corresponding structures 24, 25 in the lower and the upper die holding frame 14, 15, respectively. As a result of this pre-embossed peripheral embossing 13, the blank 12 is at least largely fixed on the holding frame 14 and does not slip out of place during a movement along the direction of the arrow 26. In so far as the license plate blank 12 does not have any peripheral embossing 13, it can be provided that the frames 14, 15 have corresponding pins, not illustrated, against which the blank is then placed.

As soon as the license plate blank 12 has been placed, the lower die holding frame 14 is moved on the rails 20 such that said lower die holding frame 14 is situated directly below the upper die holding frame 14 (FIG. 4). Furthermore, the lower die holding frame 14 including the blank 12 is lifted along the direction of the arrow 28 by a lifting installation 27 such that the blank 12 touches, or almost touches, respectively, the upper die holding frame 15. Before the two frames 14, 15 come into contact, or before the blank 12 comes into contact with the upper die holding frame, respectively, the individual negatives 17 and positives 16 are pushed together by a sliding installation, not illustrated, such that a defined alignment can be guaranteed.

The frames 14, 15, which are now converged, are situated in a plane which is congruent with a plane of a lower embossing part 29 of an embossing installation 30. The converged frames 14, 15 thereafter are relocated in the direction of the arrow 31 into the embossing installation 30, or between the lower embossing part 29 and an upper embossing part 32, respectively, by a corresponding installation (FIG. 5).

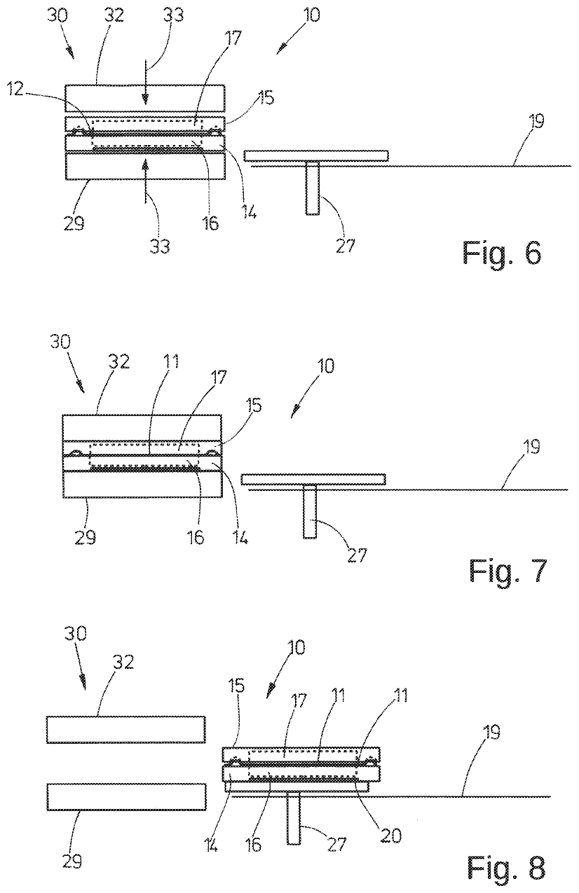

The embossing parts 29, 32 in the embossing installation 30 thereafter are converged in the direction of the arrow 33. The negatives 17 and the positives 16 here are in particular mutually compressed such that the corresponding characters are embossed in the blank 12 (FIG. 6). The embossing parts 29, 32 here are moved together to the maximum such that the embossed motor vehicle license plates 11 always have the same embossing (FIG. 7). The motor vehicle license plate 11 has now been created from the blank 12 between the die frames 14, 15.

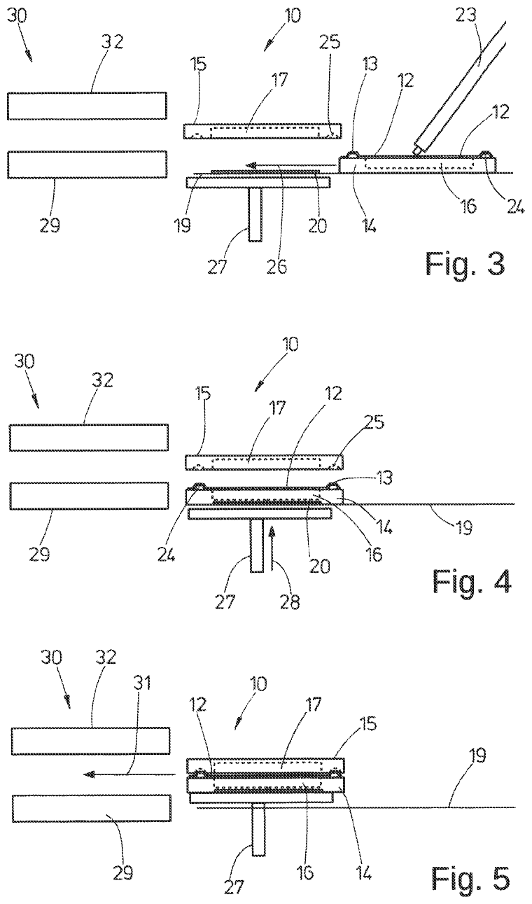

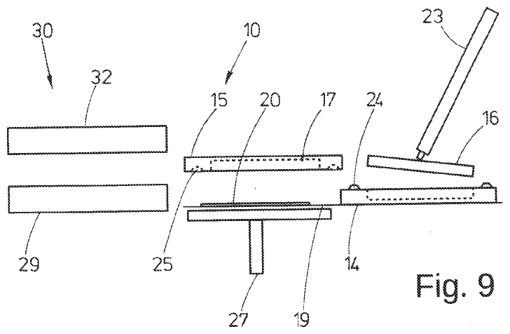

Once the license plate blank 12 in the embossing installation 30 has been embossed so as to form the motor vehicle license plate 11, the two die holding frames 14, 15 are conjointly conveyed out of the embossing installation 30 again (FIG. 8). In the further course of the method, the steps described above take place in the reverse sequence. Once the lower die holding frame 14 has been spaced apart from the upper die holding frame 15 again and been set down on the rails 20 by the lifting installation 27, the frame 14 is relocated counter to the direction of the arrow 26 to the initial position. In this initial position of the device 10, illustrated in FIGS. 3 and 9, the completed motor vehicle license plate 11 is first lifted from the lower die holding frame 14, or from the positives 16, respectively, by the acquisition means 23 and fed to an outfeed conveyor. Thereafter, a further license plate blank 12 is optionally placed onto the positives 16 by the acquisition means 23, and by the above-described method embossed so as to form a motor vehicle license plate 11, in particular the second license plate of a pair of license plates. For producing a motor vehicle license plate 11 with a new set of characters, a positive 16 is first lifted from the lower die holding frame 14 and placed at the corresponding position in the magazine by the acquisition means 23. Subsequently, the corresponding positive 16 is then lifted by the acquisition means 23 and placed onto the negative 17 in the magazine. When changing a plurality of characters or embossing dies, respectively, it is moreover conceivable for all positives 16 to be first retrieved from the lower die holding frame 14, and the corresponding negatives 17 thereafter. During the embossing procedure, the acquisition means 23 remains in a preferred procession from where said acquisition means 26 can carry out the next step in a particularly time-efficient manner.

The device according to the invention and the method according to the invention are not only suitable for producing motor vehicle license plates 11 as described above, but also for producing other license plates with an individual sequence of characters or only one individual symbol.

### LIST OF REFERENCE SIGNS

10 Device

11 Motor vehicle license plate

12 License plate blank

13 Peripheral embossing

14 Lower die holding frame

15 Upper die holding frame

16 Positive

17 Negative

18 Direction of arrow

19 Linear drive

20 Rail

21 Pin

22 Opening

23 Acquisition means

24 Structure

25 Structure

26 Direction of arrow

27 Lifting installation

28 Direction of arrow

29 Lower embossing part

30 Embossing installation

31 Direction of arrow

32 Upper embossing part

33 Direction of arrow

1. A method for embossing license plates, in particular motor vehicle license plates (11), wherein embossing dies having characters corresponding to the license plate to be embossed are individually assembled, in that the embossing dies required for the respective license plate to be embossed are retrieved from a magazine by a handing installation, a license plate blank (12) is fed to the embossing dies, and the characters in an embossing installation (30) are embossed in the license plate blank (12) by the embossing dies, wherein two die holding frames, specifically a lower die holding frame (14) and an upper die holding frame (15), which are movable relative to one another are successively populated by the handling installation with at least one positive (16) of an embossing die and with at least one negative (17) of an embossing die.

2. The method for embossing license plates as claimed in claim 1, wherein, for placing the at least one positive (16) and the at least one negative (17) onto the die holding frame (14, 15) and for lifting the at least one positive (16) and the at least one negative (17) from the die holding frame (14, 15), the lower die holding frame (14) is displaced horizontally and parallel to the upper die holding frame (15), and/or in that the upper die holding frame (15) is displaced horizontally and parallel to the lower die holding frame (14).

3. The method for embossing license plates as claimed in claim 1, wherein first at least one negative (17) of an embossing die, preferably a plurality of negatives (17) of a plurality of embossing dies, are placed onto the upper die holding frame (15), and thereafter the corresponding positive (16) of the embossing die, preferably the corresponding positives (16) of the embossing dies, are placed onto the lower die holding frame (15).

4. The method for embossing license plates as claimed in claim 1, wherein in that upon populating, or placing the at least one negative (17) and the at least one positive (16) onto the die holding frames (14, 15), respectively, the license plate blank (12) is placed by the handling installation onto the lower die holding frame (14), preferably onto the positives (16) of the embossing dies.

5. The method for embossing license plates as claimed in claim 1, wherein the upper and the lower die holding frame (14, 15) are aligned on top of one another by a horizontal and parallel relative movement, the lower die holding frame (14) being in particular displaced below the upper die holding frame (15) such that the corresponding positives (16) and negatives (17) of the embossing dies are aligned on top of one another, wherein the license plate blank (12) is positioned between the positives (16) and the negatives (17).

6. The method for embossing license plates as claimed in claim 1, wherein in the horizontal movement of the lower die holding frame (14) the holding frame (14) is guided in at least one rail (20), preferably in two rails (20).

7. The method for embossing license plates as claimed in claim 1, wherein the two die holding frames (14, 15) which are aligned on top of one another are relocated vertically relative to one another, wherein the lower frame (14) is preferably moved toward the upper frame (15) and thereafter both die holding frames (14, 15) are conjointly relocated into the embossing installation (30) in which the die holding frames (14, 15) are mutually compressed.

8. The method for embossing license plates as claimed in claim 7, wherein the two frames (14, 15) upon pressing are conjointly relocated from the embossing installation (30) and, upon vertically lowering the lower die holding frame (14) relative to the upper die holding frame (15), the lower die holding frame (14) is relocated horizontally below the upper die holding frame (15) so as to lift at least one positive (16) and at least one negative (17), and so as to repopulate the frames (14, 15) with at least one positive (16) and at least one negative (17).

9. The method for embossing license plates as claimed in claim 1, wherein the required embossing dies, in particular the required negatives (17) and positives (16), are picked and retrieved from a magazine and placed in the correct sequence onto at least one upper and at least one lower die holding frame (14, 15) by the handling installation having at least one acquisition means (23) that is movable in the three-dimensional space.

10. The method for embossing license plates as claimed in of the preceding claims claim 1, characterized in that wherein a license plate blank (12) is retrieved from at least one store and placed onto the lower die holding frame (14), or onto the positives (16), respectively, by the handling installation, wherein subsequently a further lower die holding frame is preferably populated with a further license plate blank (12) by the handling installation.

11. The method for embossing license plates as claimed in claim 1, wherein the embossed license plate blank (12) is lifted from the lower die holding frame (14), or from the positives (16) of the embossing dies, respectively, and fed to an outfeed conveyor by the handling installation, and a further embossed license plate blank (12) is in particular lifted from a further lower die holding frame, or from positives of the embossing dies, respectively, and fed to an outward conveyor by the handling installation.

12. The method for embossing license plates as claimed in claim 1, wherein lower and upper die holding frames (14, 15) of a plurality of, preferably two, embossing installations (30) are alternatingly or successively populated and replaced with negatives (17), positives (16) and license plate blank (12) by the handling installation.

13. The method for embossing license plates as claimed in claim 1, wherein for embossing license plate blanks (12) of different types, in particular of different dimensions, the die holding frames (14, 15) of the at least one embossing installation (30), and in particular also the embossing dies, are replaced so as to correspond to the shape of the license plate blank (12).

14. The method for embossing license plates as claimed in claim 1, wherein the embossing dies, in particular the positives (16) and the negatives (17), as well as embossing inserts, prior to the die holding frames (14, 15) being converged, are pushed together, centered and/or imparted in the die holding frames (14, 15) by being impinged by a lateral or vertical force, respectively, which is imparted by an actuator, in particular a centering cylinder.

15. The method for embossing license plates as claimed in claim 1, wherein prior to populating the die holding frames (14, 15) with the embossing dies, in particular the negatives (17) and positives (16), the latter are identified by the handling installation, wherein the handling installation has a sensor means by way of which corresponding identifying features of the negatives (17) and positives (16) are detected.

16. A device (10) for embossing license plates, in particular motor vehicle license plates (11), comprising at least one magazine for a supply of embossing dies, at least one store for license plate blanks (12), at least one embossing installation (30), at least one handling installation for handling the embossing dies, and two die holding frames, specifically a lower die holding frame (14) and an upper die holding frame (15), which are movable relative to one another for receiving at least one positive (16) of the embossing die and at least one negative (17) of the embossing die.

17. The device (10) for embossing license plates as claimed in claim 16, wherein the lower die holding frame (14) is able to be guided in at least one, preferably two, rail(s) (20), wherein the at least one rail (20) aligns the lower die holding frame (14) below the upper die holding frame (15).

18. The device (10) for embossing license plates as claimed in claim 16, wherein the lower and/or the upper die holding frame (15) for converging the die holding frames (14, 15) is/are assigned to a lifting means (27), and/or in that the lower and/or the upper die holding frame (14, 15) for conjoint or separate horizontal relocation is/are assigned to at least one translational motion means.

19. The device (10) for embossing license plates as claimed in claim 16, wherein the lower die holding frame (14) has at least one first means for alignment, and the upper die holding frame (15) has at least one second means for alignment, wherein the first and the second means are brought together and the die holding frames (14, 15) are mutually aligned when vertically converging the die holding frames (14, 15).

20. The device (10) for embossing license plates as claimed in claim 16, wherein the handling installation is configured in the manner of a robot and serves for placing embossing dies, in particular a positive (16) and a negative (17), required for embossing the license plate, onto the die holding frames (14, 15) whereby the handling installation has at least one acquisition means (23) which is movable in a plurality of axes in the three-dimensional space, wherein the acquisition means (23) is movable in the three-dimensional space by movable arms of the handling installation.

21. The device (10) for embossing license plates as claimed in claim 16, further comprising at least two embossing installations (30) having in each case one lower die holding frame (14) and one upper die holding frame (15), wherein both embossing installations (30) are able to be operated by the same handling installation.

22. The device (10) for embossing license plates as claimed in claim 16, wherein the embossing dies, in particular the negatives (17) and the positives (16) have identifying features, and the handling installation has a sensor installation, wherein the identifying features are able to be read by the sensor installation of the handling installation.
